(19) United States
(12) Patent Application Publication
(10) Pub. No.: US 2026/0098348 A1
(43) Pub. Date: Apr. 9, 2026

(54) ELECTROCHEMICAL CO-PRODUCTION OF HALOGEN AND HYDROGEN FROM WASTE PLASTIC

(71) Applicant: REGENTS OF THE UNIVERSITY OF MICHIGAN, Ann Arbor, MI (US)

(72) Inventors: Anne J. McNeil, Ann Arbor, MI (US); Bertrand Neyhouse, Ann Arbor, MI (US)

(21) Appl. No.: 19/350,962

(22) Filed: Oct. 6, 2025

Related U.S. Application Data
(60) Provisional application No. 63/703,574, filed on Oct. 4, 2024.

(51) Int. Cl. C25B 1/26; C08J 11/22; C25B 3/07; C25B 15/08

(52) U.S. Cl. CPC C25B 1/26; C08J 11/22; C25B 3/07; C25B 15/08; C08J 2327/06

(57) ABSTRACT

A method for coproducing a halogen and hydrogen can include dissolving at least one halogen containing polymer from a waste source in a solvent. The solvent having the at least one halogen containing polymer dissolved therein is then admixed with an alkoxide base under conditions to dehalogenate the at least one halogen containing polymer and precipitate at least one dehalogenated polymer, resulting in an admixture comprising the precipitated at least one dehalogenated polymer, a halogen salt, and an alkyl alcohol. The precipitate is separated and the halogen salt and the alkyl alcohol remain in the solvent. The halogen salt and the alkyl alcohol into an electrochemical cell, wherein upon application of a voltage, halogen ions from the halogen salt are converted to a halogen gas at the anode and the alkyl alcohol reacts at the cathode to generate an alkoxide and hydrogen gas.

### CROSS-REFERENCE TO RELATED APPLICATION

The benefit of priority to U.S. Provisional Patent Application No. 63/703,574 filed Oct. 4, 2024, is hereby claimed and the disclosure is incorporated herein by reference in its entirety.

### FIELD

The disclosure relates to a method for the co-production of a halogen and hydrogen from a halogen-containing waste plastic.

### BACKGROUND

Polymer recycling has garnered considerable attention from scientists, policymakers, and the broader public, as rising plastic pollution increasingly presents environmental and ecological hazards. In the United States, an estimated 700,000 tons of post-consumer poly(vinyl chloride) waste is generated per year while only ˜3% of that waste is recycled, with the remainder either combusted (9%) or landfilled (88%). Although numerous chemical and mechanical recycling pathways exist for certain commercial plastics (e.g., polyethylene terephthalate (PET), polyethylene, polypropylene), methodologies for PVC are limited, as conventional thermochemical processes (e.g., pyrolysis, combustion) are stymied by hazardous byproducts. Moreover, PVC is frequently processed with plasticizers, stabilizers, and lubricants to afford variable material properties. These diverse additives stifle mechanical recycling of PVC waste from different applications. The multifaceted challenges associated with PVC recycling present considerable opportunities to develop innovative, sustainable, and economical recycling routes.

Chemically recycling PVC waste could transform the carbon to generate useful polymers and the chlorine to produce chlorinated materials. Prevailing hydrothermal methods use highly alkaline mixtures and/or elevated temperatures to dechlorinate PVC, leaving behind carbonaceous char which can be thermochemically processed downstream to yield useful materials or short-chain carbon molecules. However, such processes are energy-intensive and often fail to achieve high dechlorination, which can hinder subsequent treatments. Recent advances have sought to either improve upon base-mediated dehydrochlorination by using alternative solvents (e.g., ethylene glycol, ionic liquids) or by directly functionalizing PVC to generate other commodity plastics and specialty polymers. For example, Fieser and coworkers have developed chemical pathways that convert PVC to polyethylene-like products, providing a second life for the carbon backbone while yielding synthetically useful chlorinated byproducts (e.g., chlorosilanes). Wood, Z. A.; Castro, E. C.; Nguyen, A. N.; Fieser, M. E. Conversion of waste poly(vinyl chloride) to tunable branched polyethylene products mediated by silylium ions. Chem. Sci. 2024, 15, 8766-8774.

Most chemical recycling processes described in recent literature have been aimed at forming specialty chemicals and polymers from PVC; while these provide access to a diverse range of potential end-products, their demand is not commensurate with the available volume of waste PVC. Producing commodity-scale chemicals would offer a significantly wider market to facilitate process scale-up. For instance, if all PVC waste were utilized in chlorine production—which has an annual market size of 60 million metric tons per year (˜$20 billion)—this would constitute less than 1% of demand, presenting a sizable economic opportunity. In fact, nearly 95% of all chlorine is already generated electrochemically through the chlor-alkali process, affirming the viability of a scalable, electrochemical chlorine-generation process. However, there have been no previous reports of chlorine evolution in non-aqueous electrolytes, as the chlor-alkali process relies on aqueous brine as its feedstock.

### SUMMARY

Processes of the disclosure utilize alkoxides for dehalogenation of plastic waste. It was observed that alkoxides were potent basis for PVC dechlorination, exhibiting rapid dechlorination at mild temperatures (25-65° C.). Methods of the disclosure provide an electrochemical process for waste plastic dehalogenation, leveraging the facile reactivity of alkoxides to achieve high dehalogenation rates while recycling the halogen content.

A method for generation of hydrogen and/or halogen from a waste source comprising at least one halogen containing polymer in accordance with the disclosure can include admixing the waste source with a solvent to dissolve the at least one halogen containing polymer in the waste source; admixing the solvent having the at least one halogen containing polymer dissolved therein with an alkoxide base under conditions to dehalogenate the at least one halogen containing polymer and precipitate at least one dehalogenated polymer, resulting in an admixture comprising the precipitated at least one dehalogenated polymer, a halogen salt, and an alkyl alcohol; separating the precipitated at least one dehalogenated polymer from the admixture, wherein the halogen salt and the alkyl alcohol remain in the solvent; introducing the halogen salt and the alkyl alcohol into an electrochemical cell comprising a cathode and an oppositely disposed anode, wherein upon application of a voltage, halogen ions from the halogen salt are converted to a halogen gas at the anode and the alkyl alcohol reacts at the cathode to generate an alkoxide and hydrogen gas; and recovering the halogen gas and the hydrogen gas from the electrochemical cell.

### BRIEF DESCRIPTION OF THE DRAWINGS

FIG. 1 is a schematic illustration of chlor-alkoxide-driven electrochemical co-production of chlorine and hydrogen from waste PVC in accordance with the disclosure.

FIG. 2 is a schematic illustration for chemical reduction of PVC via methoxide elimination/substitution and associated dechlorination yield determined from chloride-ion titration.

FIG. 3A is an FT-IR characterization of dechlorinated PVC.

FIG. 3B is a TGA characterization of dechlorinated PVC.

FIG. 3C shows Raman spectra for pure PVC, ˜50% dechlorinated PVC (dPVC-50), and fully dechlorinated PVC (dPVC).

FIG. 4 is a photograph of the chloride-ion titration equipment set-up, showing the sample vial on a stir plate (left), peristaltic pump (middle), and 10 mM AgNO₃ titrant solution in an amber bottle (right), and an associated schematic illustration of the chloride-ion experimental set-up and representative titration curve data.

FIG. 5A is a graph showing the chloride ion titration calibration using 10 ml of a standard solution containing 5 mM NaCl in 10 vol % DMF/H₂O and a titrant solution containing 10 mM AgNO₃ dispensed at 2.50 mL min⁻¹.

FIG. 5B is a graph showing the midpoint slopes (dV/dt) on the titration curve.

FIG. 6A-6F are graphs showing chloride ion titrations for PVC dechlorination corresponding to the three trials presented in entry 1 in the table in FIG. 2. Titration was performed using 5 mL of sample and a titrant solution containing 10 mM AgNO₃ dispensed at 2.50 mL min⁻¹ (FIGS. 6A, 6C, 6E). Midpoint slopes (dV/dt) on the titration curve are shown in FIGS. 6B, 6D, and 6F.

FIG. 7A is a graph showing chloride ion titrations for PVC dechlorination corresponding to entry 2 in the table in FIG. 2. Titration was performed using 5 mL of sample and a titrant solution containing 10 mM AgNO₃ dispensed at 2.50 mL min⁻¹.

FIG. 7B is a graph showing midpoint slopes (dV/dt) on the titration curve of FIG. 7A.

FIG. 8A is a graph showing chloride ion titrations for PVC dechlorination corresponding to entry 3 in the table in FIG. 2. Titration was performed using 5 mL of sample and a titrant solution containing 10 mM AgNO₃ dispensed at 2.50 mL min⁻¹.

FIG. 8B is a graph showing midpoint slopes (dV/dt) on the titration curve of FIG. 8A.

FIG. 9A is a graph showing chloride ion titrations for PVC dechlorination corresponding to entry 4 in the table in FIG. 2. Titration was performed using 5 mL of sample and a titrant solution containing 10 mM AgNO₃ dispensed at 2.50 mL min⁻¹.

FIG. 9B is a graph showing midpoint slopes (dV/dt) on the titration curve of FIG. 9A.

FIG. 10A is a graph showing chloride ion titrations for PVC dechlorination corresponding to entry 5 in the table in FIG. 2. Titration was performed using 5 mL of sample and a titrant solution containing 10 mM AgNO₃ dispensed at 2.50 mL min⁻¹.

FIG. 10B is a graph showing the midpoint slopes (dV/dt) on the titration curve of FIG. 10A.

FIG. 11A is a graph showing chloride ion titrations for PVC dechlorination corresponding to entry 6 in the table in FIG. 2. Titration was performed using 5 mL of sample and a titrant solution containing 10 mM AgNO₃ dispensed at 2.50 mL min⁻¹.

FIG. 11B is a graph showing the midpoint slopes (dV/dt) on the titration curve of FIG. 11A.

FIG. 12A is a graph showing chloride ion titrations for PVC dechlorination corresponding to entry 7 in the table in FIG. 2. Titration was performed using 5 mL of sample and a titrant solution containing 10 mM AgNO₃ dispensed at 2.50 mL min⁻¹.

FIG. 12B is a graph showing the midpoint slopes (dV/dt) on the titration curve of FIG. 12A.

FIG. 13A is a graph showing chloride ion titrations for PVC dechlorination corresponding to entry 8 in the table in FIG. 2. Titration was performed using 10 mL of sample and a titrant solution containing 10 mM AgNO₃ dispensed at 2.50 mL min⁻¹.

FIG. 13B is a graph showing the midpoint slopes (dV/dt) on the titration curve of FIG. 13A.

FIG. 14A is a graph showing chloride ion titrations for PVC dechlorination corresponding to entry 9 in the table in FIG. 2. Titration was performed using 5 mL of sample and a titrant solution containing 10 mM AgNO₃ dispensed at 2.50 mL min⁻¹.

FIG. 14B is a graph showing the midpoint slopes (dV/dt) on the titration curve of FIG. 14A.

FIG. 15 is a scheme for base-mediated methanolysis of DEHP plasticizers.

FIGS. 16A and 16B are graphs showing GCMS traces for methanolysis of plasticizers (A) before reaction and (B) after reaction. Results are representative of duplicate reactions.

FIG. 17 is a photograph showing reactions between various waste plastics and TBA-OMe in DMF/MeOH. PLA and PET were observed to undergo dissolution in the presence of methoxide, PS dissolved in DMF. Other plastic films remain largely intact and show no evidence of reaction.

FIG. 18 is a photograph of the copper, zinc, tungsten, titanium, and cobalt working electrodes used in linear sweep voltammetry experiments.

FIG. 19 is a photograph of the experimental setup used for hydrogen evolution measurements.

FIGS. 20A and 20B are graphs showing the Tafel analysis for different working electrode materials used in linear sweep voltammetry measurements, with FIG. 20A showing the analysis for platinum, palladium, gold, tungsten, and silver performed between 0.2-0.5 mA cm⁻² and FIG. 20B showing the analysis for copper, nickel, cobalt, zinc, and titanium performed between 2-5 mA cm⁻².

FIG. 21A is a schematic of the custom reversible hydrogen electrode (RHE).

FIG. 21B is a photograph of the RHE.

FIG. 21C is a graph of the open-circuit potential measurements of the RHE against an Ag/AgCl (1 M LiCl/MeOH) reference electrode in 1 M LiCl/MeOH.

FIGS. 22A to 22D show the effect of metal catalyst on the hydrogen evolution reaction in MeOH with FIG. 22A showing LSV measurements for platinum in different supporting electrolytes, FIG. 22B showing the corresponding Tafel analysis of FIG. 22A, FIG. 22C showing the LSV measurements for different metal catalysts in 0.1 M LiOMe/MeOH, and FIG. 22D showing a Volcano plot showing exchange current densities versus metal-hydrogen bond energy. Dashed lines are included as visual guides and do not represent data fitting. Measurements were performed in triplicate and error bars show one standard deviation.

FIG. 23 is photograph of the experimental setup used for chlorine evolution experiments, pictured here with a graphite anode. The image shows the methanol bubbler on the left, the H-cell in the middle (anode on the left, cathode on the right), and the 100 mM K₄Fe(CN)₆ gas washing bottle on the right.

FIGS. 24A and 24B are graphs of the calibration curve for K₃Fe(CN)₆ concentrations using cyclic voltammetry, with FIG. 24A showing the voltammograms at each concentration and FIG. 24B showing peak current versus concentration. Voltammograms were recorded in triplicate; error bars are smaller than the data points. The best-fit line is taken from a least-squares linear regression.

FIG. 24C is a graph showing cyclic voltammetry behavior in 1 M LiCl with that in 1 M LiClO₄ on both glassy carbon and platinum working electrodes.

FIG. 25A is a schematic showing the experimental set-up for a chlor-alkoxide electrolysis in accordance with the disclosure.

FIG. 25B is a graph showing chlorine Cl₂ faradaic efficiencies over time for electrolysis conducted at 10 mA, 20 mA, and 40 mA.

FIG. 25C is a graph showing the average faradaic efficiencies for Cl₂, MeO, and H⁺ determined from end-point measurements of the electrolyte solution.

FIG. 26A is a schematic illustration for recovering LiCl following methoxide-driven dechlorination.

FIG. 26B is a graph showing LiCl solubility in mixtures of DMF/toluene and DMF/dimethyl carbonate.

FIG. 26C is a photograph of the waste plastic materials used.

FIG. 26D is a graph showing LiCl recovery from the waste plastics of FIG. 26C using a method in accordance with the disclosure.

FIG. 27 is a graph showing chlorine faradaic efficiencies over time for electrolysis conducted at 40 mA using recycled LiCl in the anode.

FIG. 28 is FTIR spectra of PVC resin extracted from the waste products of FIG. 26C compared with chemically pure PVC_{47K}.

### DETAILED DESCRIPTION

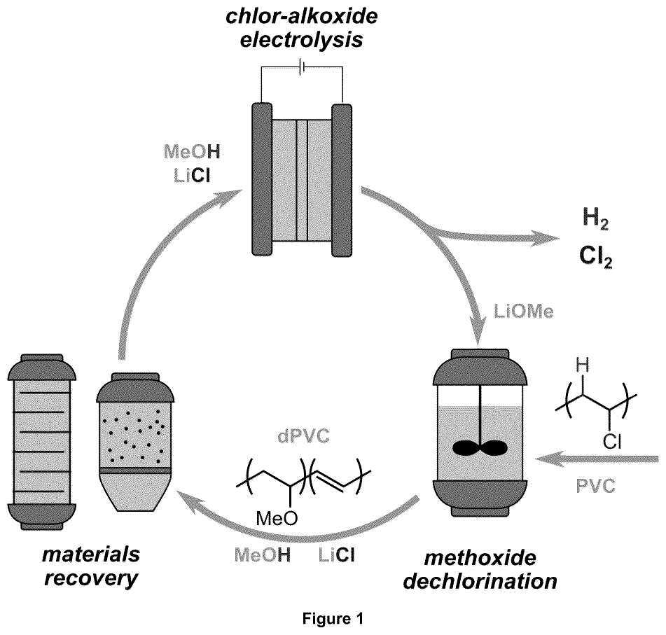

Referring to FIG. 1, a method in accordance with the disclosure advantageously provide an electrochemically mediated process for plastics recycling, enabling recovery of halogen from the plastic waste. Such recovered halogen can be recycled for plastics manufacturing and/or diverted to other halogenation processes. Additionally, methods of the disclosure can advantageously generate alkoxides in the electrochemically mediated process. Alkoxides are a highly reactive intermediate that have value in a variety of chemical processes.

Methods of the disclosure include admixing the waste source with a solvent to dissolve the at least one halogen containing polymer in the waste source, admixing the solvent having the at least one halogen containing polymer dissolved therein with an alkoxide base. The alkoxide base dehalogenates the at least one halogen containing polymer and a dehalogenated polymer precipitates out, thereby resulting in an admixture that includes the precipitate, solvent, a halogen salt, and an alkyl alcohol. The admixture precipitate is separated from the remaining admixture containing the halogen salt and the alkyl alcohol. The solvent containing halogen salt and alkyl alcohol can be directly introduced into an electrochemical cell or can be further treated to separate the halogen salt and alkyl alcohol from the solvent and any impurities that may be present in the admixture. The electrochemical cell includes a cathode and an oppositely disposed anode. Upon application of a voltage, halogen ions from the halogen salt are converted to a halogen gas at the anode. The alkyl alcohol reacts at the cathode to generate an alkoxide and hydrogen gas. The cations from the halogen salt can stabilize the reaction of the alkyl alcohol at the cathode. The hydrogen gas and halogen gas can be recovered from the electrochemical cell.

In methods of the disclosure the plastic waste is admixed with a solvent in which the at least one halogen containing polymer contained in the plastic waste is soluble. For example, the solvent can be one or more of dimethylformamide, tetrahydrofuran, dimethoxyethane, propylene carbonate, acetonitrile, methanol, ethanol, and tert-butanol. The method can include separating the solvent having the at least one halogen containing polymer dissolved therein from any remaining, undissolved portions of the plastic waste. For example, non-halogenated plastic can be included in a mixed plastic waste and would remain in solid form after treatment with the solvent. The solid non-halogenated plastic waste can be separated from the solvent, which after exposure to the mixed plastic waste contains at least one halogen containing polymer dissolved therein.

The dehalogenation of the at least one halogen containing polymer occurs upon reaction with the alkoxide base. This solvent containing the at least one halogen containing polymer can be added dropwise to the alkoxide base, for example. Other methods of mixing the solvent containing the at least one halogen containing polymer and the alkoxide base are contemplated herein, including direct mixture of the components simultaneously to a vessel or addition of one component to the other.

The dehalogenation process can be performed at a temperature of about 20° C. to about 100° C. For example, the temperature can be about 20, 25, 30, 35, 40, 45, 50, 55, 60, 65, 70, 75, 80, 85, 90, 95, 100° C., or any values therebefore or any ranges defined by such values. Beneficially, mild temperature conditions can be used with the method of the disclosure while maintaining efficient dehalogenation.

The dehalogenation process can include admixing the solvent containing the at least one halogen containing polymer and the alkoxide base for about 15 min to about 240 min, about 30 min to about 90 min, about 30 min to about 120 min, about 60 min to about 200 min, or about 20 min to about 80 min. Other suitable times include about 15, 20, 25, 30, 35, 40, 45, 50, 55, 60, 65, 70, 75, 80 85, 90 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, or any values therebefore or any ranges defined by such values.

The alkoxide and the solvent containing the at least one halogen can be combined such that the alkoxide is present in an amount of about 1 eq to about 2 eq, or about 1 eq to about 1.5 eq. relative to the amount of halogen containing polymer repeat unit present in the waste source. Lower amounts of alkoxide can be used, such as low as 0.1 eq when less than all of the halogen removal is desired.

The alkoxide can be provided in the admixture dissolved in a solvent. For example, the solvent for the alkoxide can be the same or different from the solvent in which the plastic waste is dissolved. For example, the solvent for the alkoxide can be one or more of dimethylformamide, tetrahydrofuran, dimethoxyethane, propylene, carbonate, acetonitrile, methanol, ethanol, and tert-butanol.

The alkoxide base can be methoxide base, an ethoxide base, a tert-butoxide base, or an isopropoxide base. Mixtures of alkoxide bases are also contemplate herein. For example, the alkoxide base can be tetrabutylammonium methoxide (TBA-OMe) or lithium methoxide (LiOMe).

Dehalogenation results in precipitation of a dehalogenated polymer, with the halogen salt and an alkyl alcohol remaining dissolved in the solvent. The precipitate can be separated using any known methods. For example, precipitate can be separated using vacuum filtration and centrifugation.

The remaining portion of the admixture after separation of the precipitated dehalogenated plastic waste is a solution containing the solvent, the halogen salt, and the alkyl alcohol. The halogen salt and alkyl alcohol can be recovered from the solution for introduction into the electrochemical cell. Alternatively, the solution can be directly injected into the electrochemical cells. Extraction of the halogen salt and/or alkyl alcohol can be achieved using any known methods, such as liquid-liquid extraction or precipitation of the halogen salt. For example, the halogen salt can be precipitated by admixing the solution with a non-aqueous solvent in which the halogen salt is soluble and which has low miscibility or is non-miscible with the solvent. The non-aqueous solvent can be separated form solvent due to the low or non-miscibility and the halogen salt can be precipitated out of the non-aqueous solvent. Liquid-liquid extraction can be performed, for example, by adding water and an organic solvent, resulting in a layer separation and subsequent removal of the water to separate the halogen salt.

The halogen salt and alkyl alcohol, whether separated or directly used, are introduced into an electrochemical cell. The cell includes an anode and a cathode. The cell can be a divided cell having a separator between the anode and the cathode. The separator can be, for example, a cation exchange membrane or porous separator. The electrolyte present in the electrochemical cell can be, for example, methanol containing lithium chloride, tetramethylammonium chloride, or tetrabutylammonium chloride.

Upon application of a voltage to the electrochemical cell, the halogen ions from the halogen salt are converted to a halogen gas at the anode and the alkyl alcohol reacts at the cathode to generate an alkoxide and hydrogen gas. The alkoxide, halogen gas, and hydrogen gas can be recovered from the electrochemical cell. The current density of the electrochemical cell for the production of hydrogen, halogen, and alkoxide can be about 1 mA/cm² to about 1 A/cm².

The alkoxide generated from the electrochemical cell can be recycled in the process for dehalogenation of a further waste source.

In any of the methods of the disclosure, the waste source can be any source with a halogen-containing polymer. For example, the waste source can be poly(vinyl chloride). Mixed plastic waste sources can also be treated by the methods of the disclosure, where the method acts upon the halogen-containing polymer. The waste source can include halogenated and non-halogenated polymers. The non-halogenated polymers can include polyolefins and/or one or more polymers with an ester functionality. For example, the polyolefin present in the waste source can be one or more of low-density PE (LDPE), high-density PE (HDPE), polypropylene (PP), and polystyrene (PS). For example, the one or more polymers with an ester functionality comprises poly(lactic acid) (PLA) or polyethylene terephthalate (PET). The waste source can include any common plastic additives, such as, but not limited to plasticizers. For example, the plasticizer can be a phthalate plasticizer, for example di-2-ethylhexyl phthalate (DEHP). It has been observed that the presence of non-halogenated and plastics additives, such as plasticizers, does not adversely affect the co-production of halogen and hydrogen in the methods of the disclosure.

The halogen of the halogen containing polymer can be Cl, F, I, or Br. Chlorinated polymers can include polyvinyl chloride and polyvinylidene dichloride. PVC having more chlorination as compared to standard PVC (generally referred to as cPVC) can also be treated by methods of the disclosure. Fluorinated polymers can include PVDF, PVF, and Teflon. Dechlorinated PVC is generally referred to herein as dPVC without regard to the degree or level of dechlorination.

### EXAMPLES

### Chemicals

Unless otherwise noted, chemicals were stored on the benchtop. Potassium hexacyanoferrate (II) (ReagentPlus, ≥98.5%), potassium hexacyanoferrate (III) (ACS reagent, ≥99.0%), poly(vinyl chloride) (average Mw˜43,000, average Mn˜22,000), poly(vinyl chloride) (average Mw˜80,000, average Mn˜47,000), poly(vinyl chloride) (average Mw˜233,000, average Mn˜99,000), tetrabutylammonium methoxide solution (20% in methanol), hydrochloric acid (ACS reagent, 37%), tridecane (analytical standard), dioctyl phthalate (≥99.5%), and tetrahydrofuran (≥99.0%, contains 250 ppm BHT as inhibitor) were obtained from Sigma Aldrich and used as received. Silver nitrate (ACS, 99.7%) and lithium methoxide (98+%) were obtained from Fisher and used as received. Ferrocene (99%) and copper (II) sulfate pentahydrate (99%) were obtained from Alfa Aesar and used as received. Nitric acid (extra pure, 60% solution in water) was obtained from Acros Organics and used as received. Deionized water (≥18 MΩ) was obtained from a Millipore Synergy® water purification system. Toluene was collected from an MBraun MB-SPS solvent dispensing system.

Molecular sieves (3 Å, rods, ˜1.6 mm) were obtained from Sigma Aldrich and activated at 240° C. under high vacuum for 24 h prior to use. Dimethylformamide (HPLC, ≥99.9%) was obtained from Sigma Aldrich and dried over 3 Å molecular sieves for at least 3 days prior to use. Methanol (anhydrous, 99.9%) was obtained from Alfa-Aesar and dried over 3 Å molecular sieves for at least 3 days prior to use. Lithium chloride (99%, extra pure) was obtained from Acros Organics, dried at 110° C. under high vacuum for 18 hours, and subsequently stored in the glovebox. Sodium chloride (≥99.5%) was obtained from Sigma Aldrich and dried at 120° C. in an oven for 2 hours and stored in a desiccator. Tetramethylammonium chloride (>98.0%) was obtained from TCI Chemicals, recrystallized in ethanol, filtered, dried under high vacuum, and stored in the glovebox. Tetrabutylammonium chloride (97%) was obtained from Sigma Aldrich, recrystallized in a mixture of acetone/diethyl ether, filtered, dried under high vacuum, and stored in the glovebox.

### Equipment

Fourier transform infrared (FTIR) spectroscopy was performed using a Thermo Scientific Nicolet iS50 FTIR spectrometer with a germanium attenuated total reflectance (ATR) attachment (PIKE Technologies GladiATR). Measurements were recorded between 4000-600 cm⁻¹, taking 64 scans at a resolution of 4 cm⁻¹. Scans were baseline corrected using OMNIC software for PVC extraction from commercial samples, FTIR was performed using an Agilent Cary 630 FTIR spectrometer with a diamond attenuated total reflectance (ATR) attachment. Measurements were recorded between 4000-425 cm⁻¹, taking 8 scans at a resolution of 4 cm⁻¹. All samples were ground using a mortar and pestle until they were a fine powder and placed directly on the ATR crystal.

Thermogravimetric analyses (TGA) were conducted using a TA Instruments Q50. All samples were analyzed using platinum sample pans under a N 2 flow rate of 50 mL min⁻¹. The temperature was increased from ˜27° C. to 550° C. at a ramp rate of 10° C. min⁻¹ with a 20-minute hold at 350° C., corresponding to the dehydrochlorination plateau. The TGA was calibrated using alumel and nickel standards.

Raman spectroscopy was conducted using a Renishaw inVia confocal Raman microscope equipped with a 532 nm laser. All scans were recorded over a range of 100-3200 cm⁻¹ with three accumulations and background corrected using the Renishaw WIRE software. Pure PVC₄₇ₖ samples were analyzed using 100% laser power while dechlorinated PVC samples were analyzed using 1% laser power to avoid sample burning.

¹H NMR spectra were acquired at room temperature using a 400 MHz NMR spectrometer (Varian). Chemical shift data are reported relative to tetramethylsilane and referenced to the residual solvent peak.

All electrochemical measurements were performed using a BioLogic VSP potentiostat equipped with EC-Lab software (V11.50).

GCMS was conducted using a Shimadzu GC-2010 gas chromatograph equipped with Restek Rtx-5 capillary columns and a Shimadzu GC-MS-QP2010S mass spectrometer. The GC was initially held at 55° C. for 2 minutes, ramped at 10° C. min⁻¹ to 270° C. and held for 5 minutes.

### Example 1: Evaluation of Alkoxide Bases for PVC Dechlorination at Mild Temperature

Reaction conditions for maximizing methoxide elimination and substitution were evaluated to provide a process of achieving near-quantitative dechlorination with mild temperatures and limited excess base. Tetrabutylammonium methoxide (TBA-OMe) and lithium methoxide (LiOMe) solutions were used. Initially, the alkoxide solutions were added dropwise to stirring solutions containing PVC (MW=22 kDa) dissolved in DMF at room temperature. Methoxides react rapidly with PVC, displaying near-immediate color changes upon addition, shifting from a clear solution to brown to black over time. After ca. 0.8 equivalents have been added, solid dechlorinated products begin to precipitate, limiting the accessibility of the polymer to the soluble alkoxides. Indeed, the dechlorination efficiency under these conditions was limited to ˜78% as evinced by titration of the reaction solution.

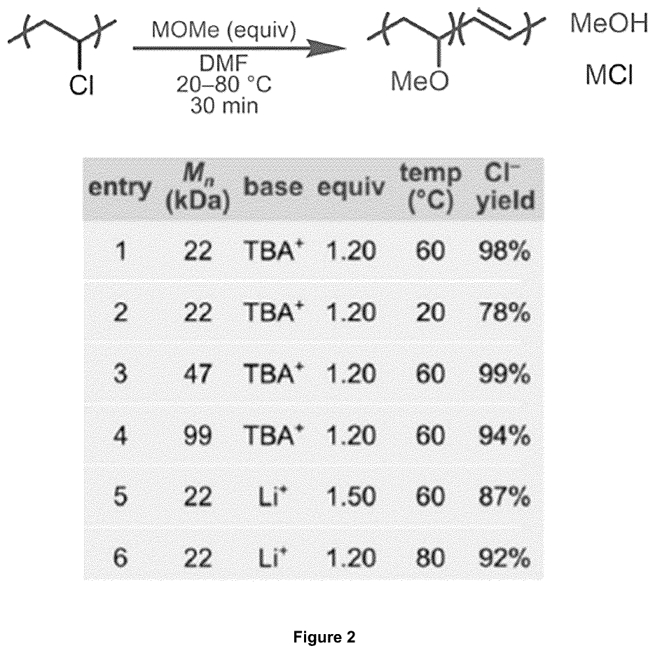

When the order of addition was reversed, with PVC added to the alkoxide solution, an increase in dechlorination was observed, alongside some precipitation. Increasing the temperature and providing a slight excess of methoxide enabled up to 98% dechlorination. Without intending to be bound by theory, it is believed that the temperature accelerates reaction rates between the methoxide and PVC while slowing the polymer precipitation rate, allowing partially dechlorinated dPVC to remain in solution longer. Using this procedure on higher MW PVC substrates yielded comparable results, with the highest MW sample (101 kDa) reaching 94% dechlorination. Presumably, precipitation proceeds more quickly for larger polymers, limiting the dechlorination rate. Switching to LiOMe lowered the dechlorination yields to 87% at the same temperature (FIG. 2, entry 5), consistent with a slower observed color change despite some excess base (1.50 equiv). Stronger ion-pairing between the lithium and MeO ions was believed to weaken reactivity of the base. 92% dechlorination was achieved using LiOMe (1.20 equiv) with a temperature of 80° C. (FIG. 2, entry 6).

The dechlorinated polymer products were completely insoluble in common organic solvents. As such, the dechlorinated products were analyzed via FT-IR and thermogravimetric analysis to confirm dechlorination and understand general structural characteristics of the polymer. To limit exposure to air and water, which could potentially oxidize alkenes and/or promote cross-linking, the reaction was repeated under conditions (1.2 equiv TBAOMe, 60° C.) using PVC_{47K} in a nitrogen-filled glovebox. An additional sample dPVC-50 was prepared using 0.50 equiv. TBAOMe to provide a midpoint between unreacted PVC_{47K} and fully dechlorinated PVC. For dPVC, DMF (8 mL) was added to a 15 mL round-bottom flask and stirred at 800 rpm at 60° C. The 20 wt % TBAOMe solution (2.625 g, 1.20 equiv) was added directly to the flask and stirred for 5 min. Separately, 100 mg of PVC₄₇ₖ was dissolved in 5 mL of stirring DMF in a scintillation vial at room temperature. The PVC solution was added dropwise to the reaction flask over about 3 min using a glass pipette. The reaction was then allowed to proceed for 30 min. After the reaction, the dPVC suspension was poured directly into a disposable 10 μm polyethylene frit, filtered, and washed twice with 10 mL MeOH to remove residual solvent. The resulting product was dried under high vacuum overnight (16 h) to give the final dPVC (46.7 mg).

For dPVC-50, DMF (10 mL) and PVC (100 mg) were added to a 25 mL round bottom flask and stirred at 800 rpm at 60° C. The 20 wt % TBAOMe solution (1.094 g, 0.50 equiv) was added dropwise to the reaction flask over about 3 min using a glass pipette. Here′ the order of addition was reversed to avoid inhomogeneity in the polymer product. The reaction was allowed to proceed for 30 min. As the product did not precipitate during the reaction, the reaction solution was poured into 50 mL of stirring MeOH. The black precipitate was then filtered and washed twice with 10 mL of MeOH. The resulting product was dried under high vacuum overnight (16 h) to give the final dPVC-50 (60.8 mg).

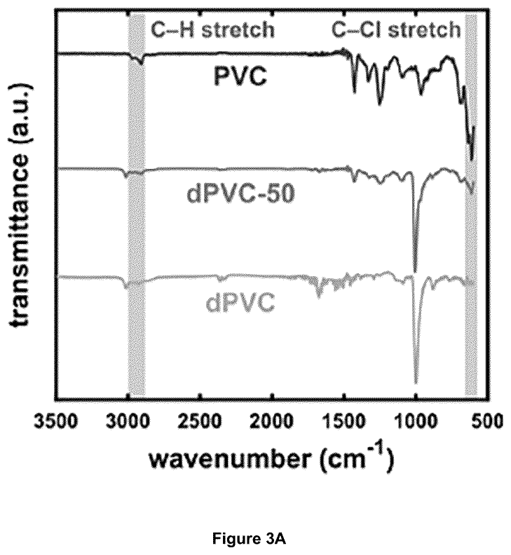

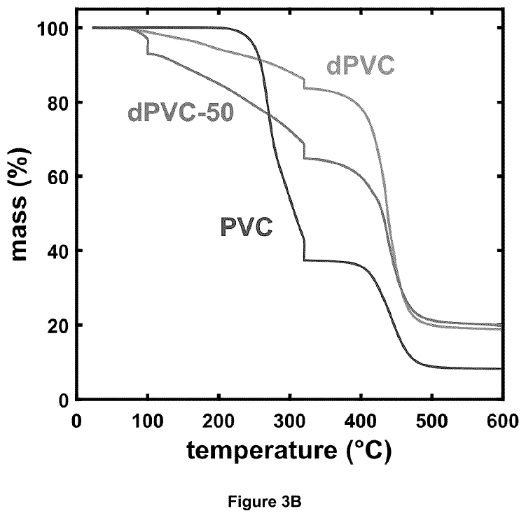

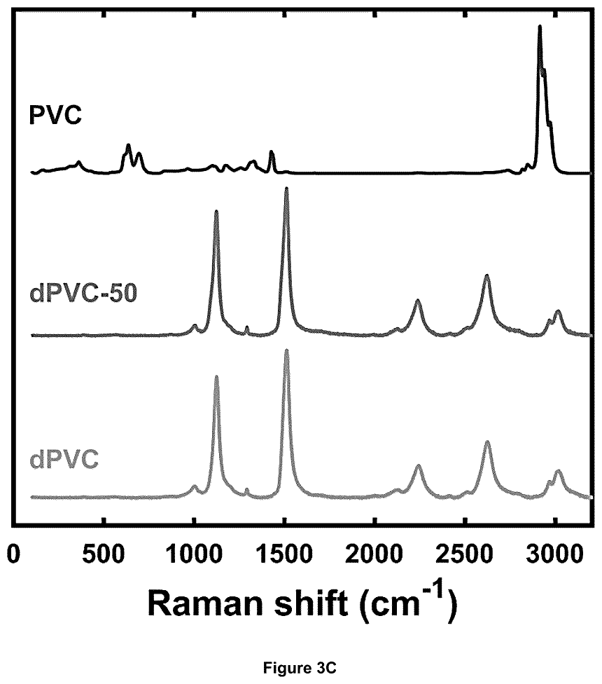

Dechlorination is reflected in TGA measurements (FIG. 3A), which display a marked reduction in mass loss compared to untreated PVC, which features a 59% mass loss at 320° C. corresponding to HCl loss alongside some aromatic carbon. FTIR (FIG. 3B) shows clear structural changes, including the C—Cl stretch at 616 cm⁻¹ is absent in dPVC, confirming chlorine loss. The C—H stretch shifting above 3000 cm⁻¹ suggests alkene formation, which is consistent with an insoluble polyacetylene-like backbone formed via elimination, which is believed to be followed by a zipper mechanism. Raman spectra (FIG. 3C) for dPVC-50 and dPVC displayed prominent polyacetylene bands around 1100 cm⁻¹ and 1500 cm⁻¹, however strong resonance drowned out C—Cl features and masked signatures for C—O incorporation (e.g., C—O stretching near 800 cm⁻¹, symmetric CH₃ stretching near 2820 cm⁻¹. While spectra for both dPVC-50 and dPVC were distinct from PVC, they were nearly identical, showing strong features resembling polyacetylene. Each of the dominant bands around 1100 cm⁻¹ (C—C bonds overlapping C—H vibrations), 1500 cm⁻¹ (C═C stretching), 2200 cm⁻¹ (harmonic of the 1100 cm⁻¹ band), and 2600 cm⁻¹ (mixing of the 1100 cm⁻¹ and 1500 cm⁻¹ bands) were previously reported for polyacetylene. As noted above, the similarities between dPVC-50 and dPVC are believed to be due to resonance effects. Elemental analysis provided evidence for oxygen incorporation, which was estimated at 5:1 ratio of polyacetylene:methoxide repeat units in dPVC.

The Table below shows the elemental analysis for dechlorinated polymers with the theoretical elemental distribution for pure PVC. It was assumed that any remaining mass not measured by elemental analysis, which measures carbon, hydrogen, nitrogen, and chlorine, is attributed to oxygen. Additionally, it was assumed that the small nitrogen content is due to trace DMF absorbed in the slid product. Accounting for the possibility of three repeat units—PVC, polyacetylene (PA), and poly(vinyl methyl ether) (PVNE)—allowed for an estimation of the molar composition of the polymer. The remaining oxygen that was not associated with DMF was used to calculate the PVME fraction. The remaining chlorine was used to calculated the PVC fraction. After accounting for carbon from the PVC and PVME repeat units, the remaining carbon was assigned to PA. For dPVC-50, this gave a molar composition of 37.1% PVC, 60.4% PA, and 2.5% PVME, which was slightly higher than expected stoichiometric dechlorination. For dPVC, this gave a molar composition of 5.1% PVC, 78.6% PA, and 16.3% PVME, which was within error of the measured chlorine yield.

TABLE
Elemental Analysis for PVC, dPVC-50, and dPVC

| Atom | PVC^{a} | dPVC-50 | dPVC |
|---|---|---|---|
| C | 38.44 | 60.09 | 77.55 |
| H | 4.84 | 6.27 | 7.54 |
| N | 0 | 0.18 | 1.03 |
| Cl | 56.72 | 32.27 | 5.20 |
| O^{b} | 0 | 1.19 | 8.68 |

^{a}Theoretical composition
^{b}Calculated as the remainder of mass

### Example 2: PVC Dechlorination and Chloride Ion Titration

8 mL of DMF was added to a 25 mL round-bottom flask, stirred at 800 rpm with a PTFE stir bar and sparged with N₂ for 15 min. Methoxide solutions were taken from the glovebox and added directly to the flask under a N₂ blanket. The 20 wt. % TBA-OMe solution was used directly while LiOMe was dissolved in ˜4 mL of anhydrous MeOH prior to addition. Separately, 100 mg of PVC was dissolved in 5 mL of stirring DMF in a scintillation vial and sparged with N₂ for 10 minutes. The PVC solution was added dropwise to the reaction flask over ˜3 min using a glass pipette. The reaction was then allowed to proceed for 30-120 min. After ˜5 min, black solids had precipitated from the mixture and the mixture appeared as a dark brown suspension. After the reaction was complete, the mixture was poured directly into ˜150 mL of DI water. Another ˜30 mL of DI water was used to wash residual solution and solids from the reaction flask. The mixture was vacuum filtered through a disposable frit, adjusted to a final volume of 200 mL using a volumetric flask, and taken for chloride titration. The table in FIG. 2 provides the base used and reaction conditions for the dechlorination processes performed.

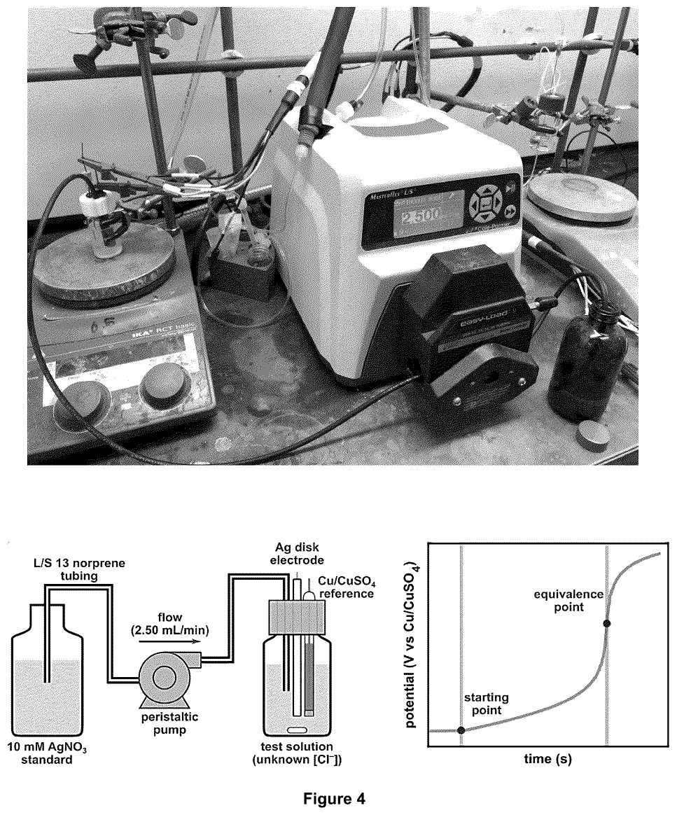

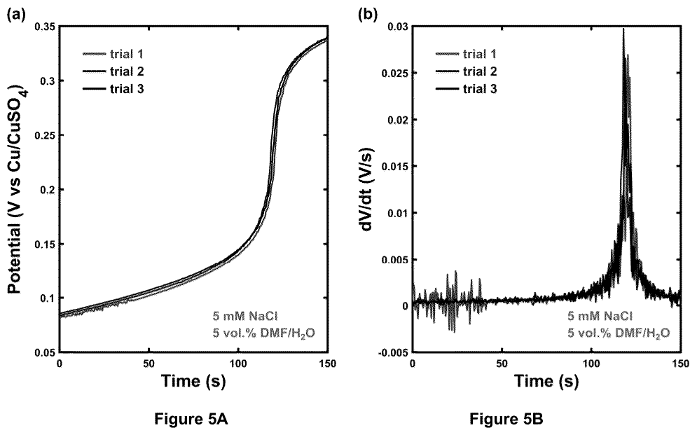

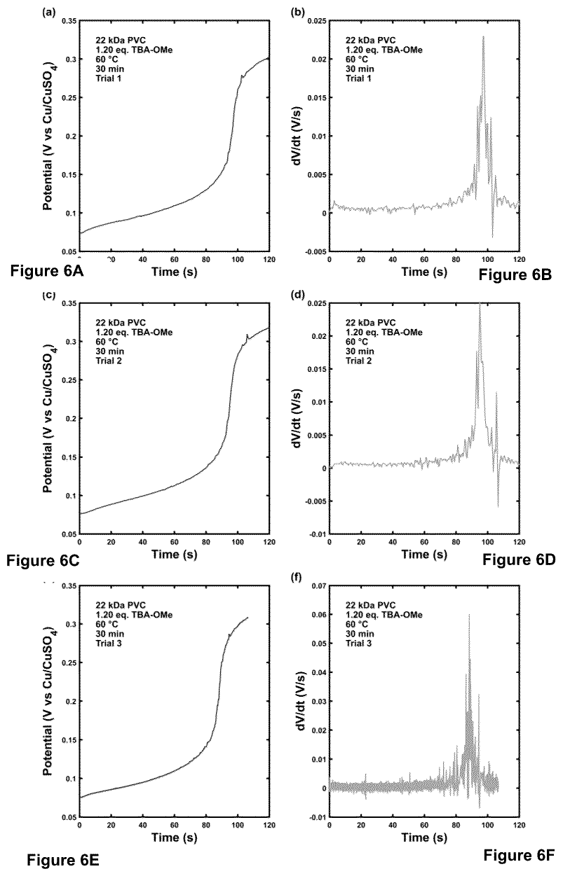

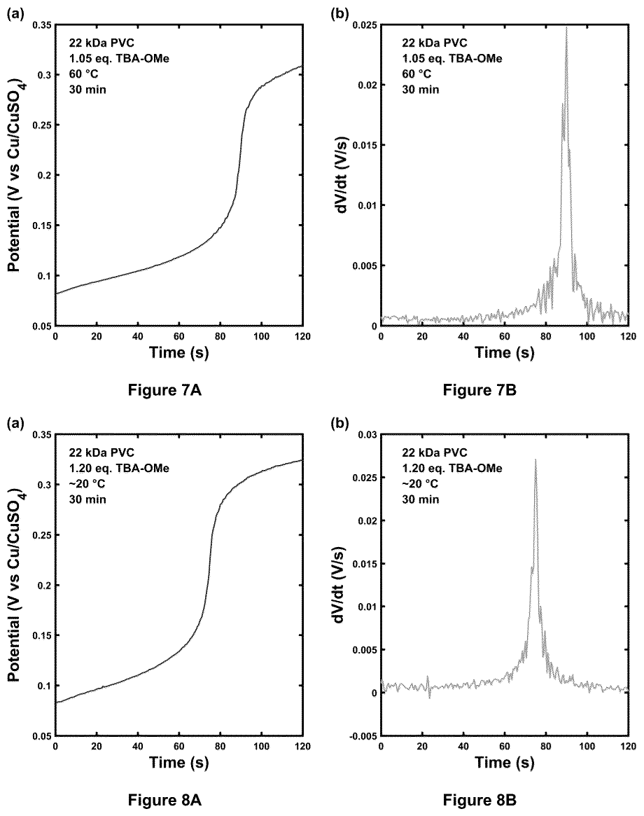

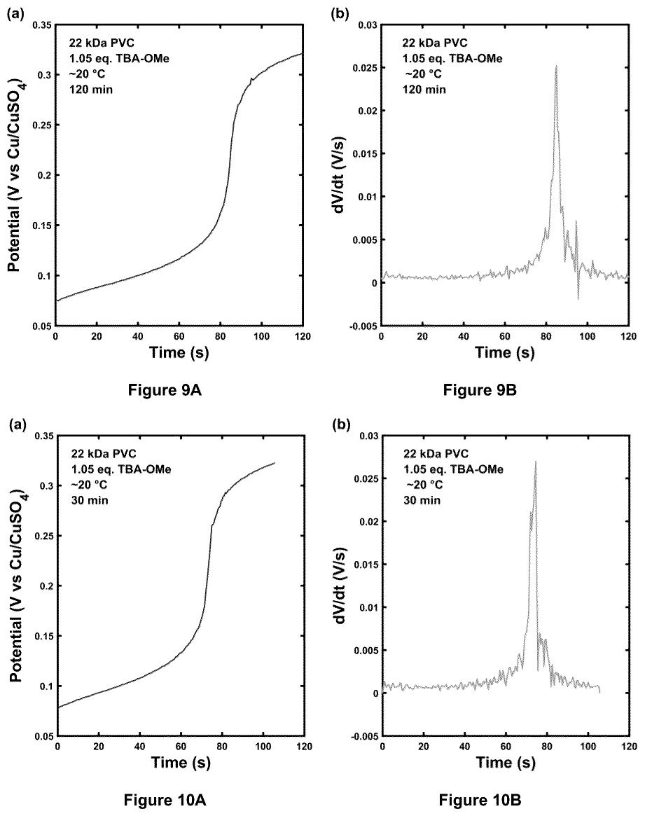

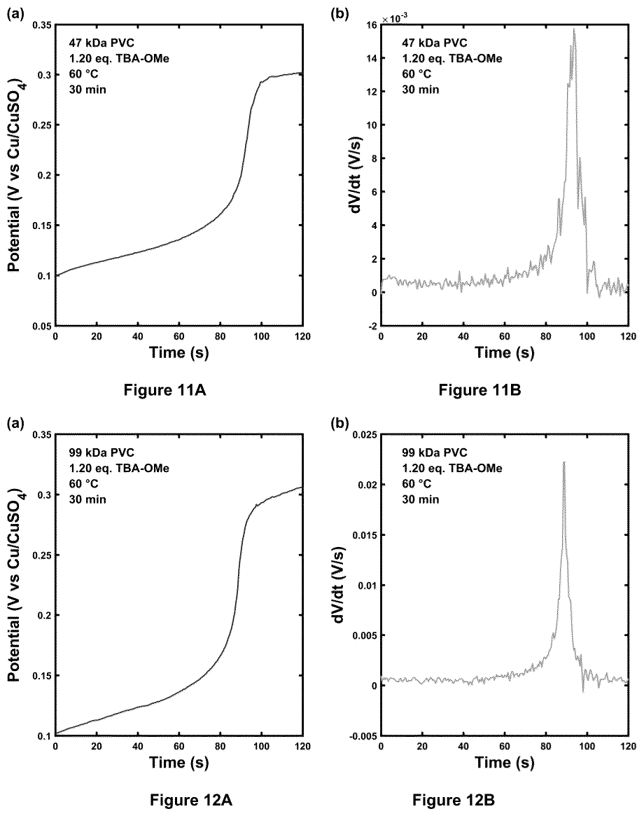

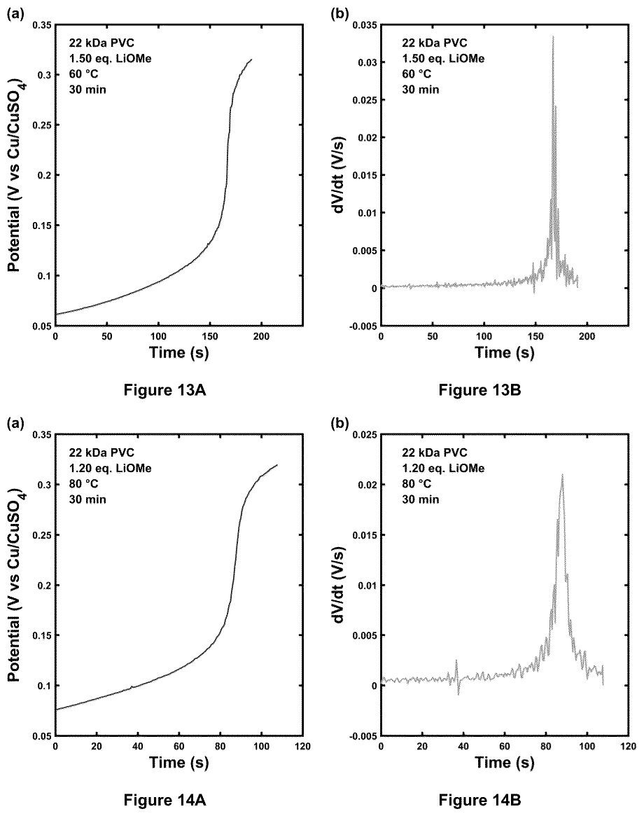

Chloride concentrations were determined using potentiometric titration with an aqueous 10 mM AgNO₃ standard using an equipment set-up as shown in FIG. 4. A pre-determined sample volume (i.e., 5 or 10 mL) was measured using a volumetric flask, added to a fresh 20 mL scintillation vial, and stirred at 900 rpm. When using 5 mL of sample, an additional 5 mL of DI water was added to rinse the volumetric flask. The open-circuit potential was measured using a silver disc working electrode (CH Instruments) and a copper reference electrode prepared using a copper wire immersed in 0.1 M CuSO₄ and separated by a glass frit. The initial open-circuit potential was measured for ˜30 seconds to establish a baseline, and then the titrant solution was dispensed at 2.50 mL min⁻¹ using a Masterflex peristaltic pump equipped with L/S 13 Norprene tubing. The starting point (time=0) was determined as the time when the potential deviates from the initial baseline. All titration curves are plotted from the starting point. The equivalence point was determined by the time with the largest midpoint slope on the titration curve. Prior to each set of measurements, the silver disc was polished on a microfiber cloth using a 0.05 μm alumina slurry and the peristaltic pump was calibrated using the 10 mM AgNO₃ solution. An initial calibration using 5 mM NaCl in 5 vol. % DMF/H₂O yielded a concentration of 4.97±0.05 mM when performed in triplicate. FIGS. 6 to 14 illustrate the chloride ion titration results for the PVC dechlorination using the reaction conditions as identified in the Table in FIG. 2.

### Example 3: Effect of Plasticizer in the Plastic Waste

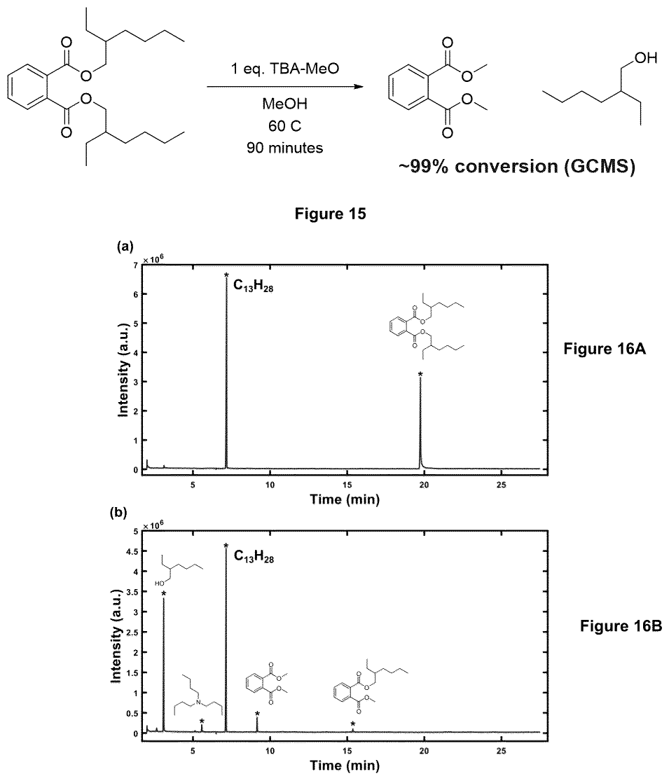

The role of common additives and other waste plastics in the efficiency of dechlorination was evaluated. Phthalate plasticizers (e.g., di-2-ethylhexyl phthalate (DEHP)) are among the most common additives in PVC, affording flexible products like tubing and flooring. Referring to FIG. 15, these species readily undergo methanolysis under the reaction conditions employed here. Indeed, subjecting DEHP to 1 equivalent of methoxide (0.5 equivalent relative to the ester groups) resulted in complete conversion to dimethyl phthalate and 2-ethylhexanol as products. However, methanolysis only results in consumption of MeOH (solvent) without consuming the methoxide (base), meaning the presence of DEHP should not meaningfully limit dechlorination efficiency.

Reaction with a model phthalate plasticizer (DEHP) was carried out using comparable conditions to PVC dechlorination. 1 mmol of DEHP (0.395 g) and 1 mmol tridecane (0.244 mL) were added to 5 mL DMF in an 8 mL septa-capped scintillation vial and sparged with N₂ for 10 minutes. 1.367 g of 20% TBA-OMe (mmol) in MeOH was injected into the vial using a syringe and gently mixed. The vial was then placed on a heating block and allowed to sit at 60° C. for 90 minutes. To analyze the solution composition before and after the reaction, 0.1 mL of solution was added to ˜3 mL diethyl ether and syringe filtered into a 2 mL sample vial. Referring to FIG. 16, DEHP conversion was determined using GCMS by comparing the area under the DEHP peak with that of the tridecane standard. Products were identified using the highest similarity score for the instrument's internal compound library. The reaction was performed in duplicate.

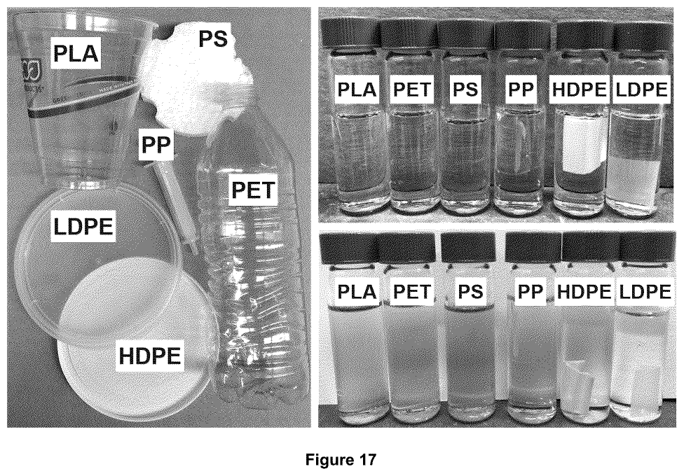

Referring to FIG. 17, various waste plastic materials were subjected to the same reaction conditions. Common polyolefins (e.g., low-density PE (LDPE), high-density PE (HDPE), polypropylene (PP)) and polystyrene (PS) display no reactivity in the presence of TBA-OMe in DMF. Conversely, plastics featuring ester functionalities (i.e., poly(lactic acid) (PLA), polyethylene terephthalate (PET)) undergo methanolysis, similar to DEHP, as indicated by complete dissolution of the plastic films following methoxide addition. While mixed waste containing these plastics may complicate PVC recycling, these plastics could potentially be recycled alongside PVC.

### Example 4: Electrochemical Analysis of Hydrogen Evolution

Platinum (2 mm diameter), gold (2 mm diameter), and silver (2 mm diameter) working electrodes were obtained from CH Instruments. Palladium (3 mm diameter) and nickel (3 mm diameter) working electrodes were obtained from BASi. Copper, titanium, tungsten, zinc, and cobalt working electrodes were prepared in-house. 110 copper rod (⅛″ diameter, ½′ length) and 360 brass rods (⅛″ diameter and 2 mm diameter) were obtained from McMaster-Carr. A pure tungsten rod (WESTWARD, ⅛″ diameter, 7″ length) was obtained from Grainger. Titanium rod (99.99%, ⅛″ diameter, 5 cm length) and zinc wire (99.95%, ⅛″ diameter, 10 m length) were obtained from Fisher. Cobalt wire (99.95%, 2 mm diameter, 5 cm length) was obtained from Sigma.

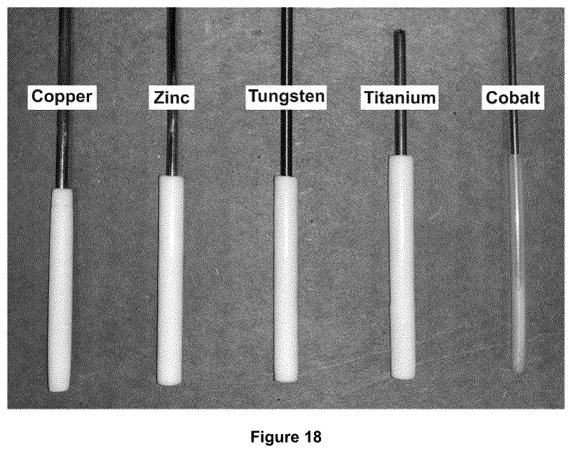

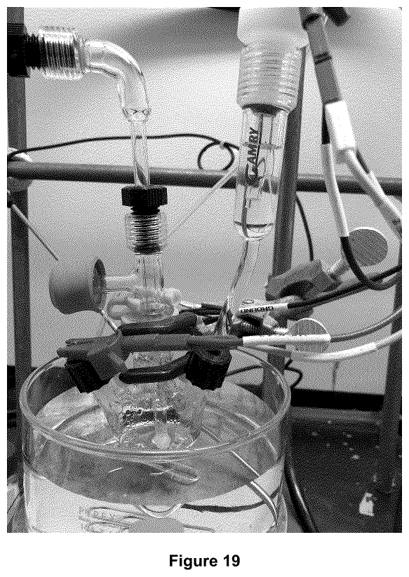

Referring to FIG. 18, the copper, zinc, and tungsten electrodes were prepared by driving the pure metal rods through a 6 cm length of 3 mM diameter PTFE tubing until the metal was flushed with the surface. The titanium electrode was prepared by cutting a ˜1 cm piece of titanium rod and driving it through a 6 cm length of 3 mM PTFE tubing until the metal was flushed with the surface. To establish an electrical connection, the tip of the ⅛″ diameter brass rod (4″ length) was coated with conductive silver epoxy and driven through the PTFE tube until contact was made with the titanium. The epoxy was then allowed to set for 12 hours prior to use. The cobalt electrode was prepared similarly to the titanium except that the 2 mm brass rod was used with 2 mm diameter PTFE tubing. All electrodes were polished sequentially with increasingly fine wetted alumina sandpaper from 240-3000 grit. Finally, the electrodes were polished on a microfiber polishing pad with a 0.05 μm alumina slurry to give a mirror finish.

Ag wire was immersed in an aqueous 1 M HCl solution in a 20 mL scintillation vial and oxidized at ca. 0.4 mA cm⁻² for 2 h with a Pt wire counter electrode. The Ag wire was then rinsed with anhydrous MeOH and then immersed in anhydrous MeOH for at least 4 days to remove any residual HCl and H₂O. The wire was added to a fritted nonaqueous reference electrode body (BASi), equipped with a CoralPor frit, containing either 1 M LiCl, TMA-Cl, or TBA-Cl, depending on the analyte solution. During HER measurements, the reference electrode was separated by a fritted double junction (Gamry) to avoid methoxide contamination; the double junction was filled with ˜3 mL of the reference electrode solution and sparged with N₂ for 10 minutes before sealing.

Linear sweep voltammetry experiments were performed in an airtight three-electrode cell equipped with a metal disk working electrode, Pt wire counter electrode, and Ag/AgCl reference electrode. 10 mL of freshly prepared electrolyte was added, and the cell was sparged with MeOH-saturated N₂ for 15 minutes while stirring at 800 rpm. The cell was held in a room temperature water bath with constant temperature between 22.0-22.5° C. When changing the working electrode during HER measurements or adding LiCl during chlorine evolution measurements, the cell was sparged again for 5 minutes. LSV measurements were conducted at 50 mV s⁻¹ under quiescent conditions. The ohmic drop was determined using the ZIR technique (100 kHz), and an 85% IR-correction was applied during the measurement with the remaining 15% corrected after the measurement to avoid experimental noise. Voltammograms were measured in triplicate. For platinum group metals (Pt, Pd, Ni), the electrode was polished between measurements. For all other electrodes, the solution was stirred and sparged with MeOH-saturated N₂ between each measurement.

FIG. 20 shows preliminary linear sweep voltammetry (LSV) measurements with a platinum disk electrode in 1 M TBA-Cl. Voltammograms displayed an exponential growth in current following the onset of HER. Indeed, when scanning at lower scan rates (<10 mV s⁻¹), bubble formation can be observed on the platinum surface, which is indicative of hydrogen gas formation. To quantitatively analyze the electrochemical kinetics, a Tafel analysis was employed (Equation (1)) by plotting the logarithm of the current density against the applied overpotential.

$$i = {i}_{o} exp ( \frac{{α}_{c} F}{RT} ( E - {E}^{0 {,}^{′}} ) ) \qquad ( 1 )$$

Here, i (mA cm⁻²) is the current density, iₒ (mA cm⁻²) is the exchange current density, α_{c} (−) is the transfer coefficient, F (96,485 C mol⁻¹) is the Faraday constant, R (8.314 J mol⁻¹ K⁻¹) is the universal gas constant, T (K) is the absolute temperature (298 K), E (V vs Ag/AgCl) is the applied electrode potential, and E^{0,′} (V vs Ag/AgCl) is the formal reduction potential.

HER is generally assumed to proceed via three primary mechanistic steps—the Volmer step (Equation (2)), the Heyrovsky step (Equation (3)), and the Tafel step (Equation (4)), which have been adapted to MeOH from their aqueous analogues. Note that * represents an open surface adsorption site.

$$MeOH + {e}^{-} + * \to {MeO}^{-} + H * \qquad ( 2 )$$

$$H * + MeOH + {e}^{-} \to {MeO}^{-} + {H}_{2} \qquad ( 3 )$$

$$H * + H * \to {H}_{2} \qquad ( 4 )$$

Different rate-determining steps give rise to unique transfer coefficients, leading to distinct Tafel slopes that shed light on the underlying mechanism. For a reaction with a single-electron-transfer rate-limiting step (Volmer mechanism), the theoretical Tafel slope at room temperature is 118 mV dec⁻¹, corresponding to a transfer coefficient of 0.5. Quantitative agreement is not expected due to a mix of rate limiting factors, but this value provides foundational insight into the electron-transfer process.

For tetraalkylammonium salts (TBA-Cl, TMA-Cl), large Tafel slopes were observed, nearly twice as large as the theoretical value for a one-electron-transfer process. Typically, larger Tafel slopes can be attributed to mass transport limitations, however stirring and/or sparging the electrolyte yielded little changes to the recorded slope. Investigating HER in EtOH, Wang et al. found similarly large Tafel slopes when using tetraalkylammonium bromide, which they suggested was due to competitive adsorption of bulky cations on the Pt surface. However, few works have investigated hydrogen evolution in alcohols, and studies in this area have primarily explored electrochemical routes to prepare metal alkoxide salts for use in chemical synthesis.

Leveraging extensive research in aqueous HER, it is believed that switching to smaller alkali metal cations would yield lower Tafel slopes. Indeed, LiCl displayed a much lower Tafel slope (145 mV dec⁻¹), approaching the theoretical value of 118 mV dec⁻¹. Other alkali metal chlorides (i.e., sodium, potassium) are relatively insoluble in MeOH, barring their use here. The remaining ˜30 mV difference in Tafel slope can be attributed to local changes in pH, as MeOH reduction generates a methoxide ion concentration gradient that shifts the equilibrium HER potential. Conducting LSV measurements in electrolytes containing 0.1 M LiOMe—mimicking alkaline HER measurements that are typically conducted at pH 13—yields a Tafel slope (111 mV dec⁻¹) in agreement with the anticipated theoretical value. Interestingly, Monteiro et al. showed that, under aqueous conditions (pH 13), lithium-containing electrolytes display Tafel slopes of ca. 40 mV dec⁻¹, consistent with a second electron transfer rate-limiting step (Heyrovsky mechanism). Thus, although HER in MeOH displays similarities to alkaline HER, there are likely underlying mechanistic differences.

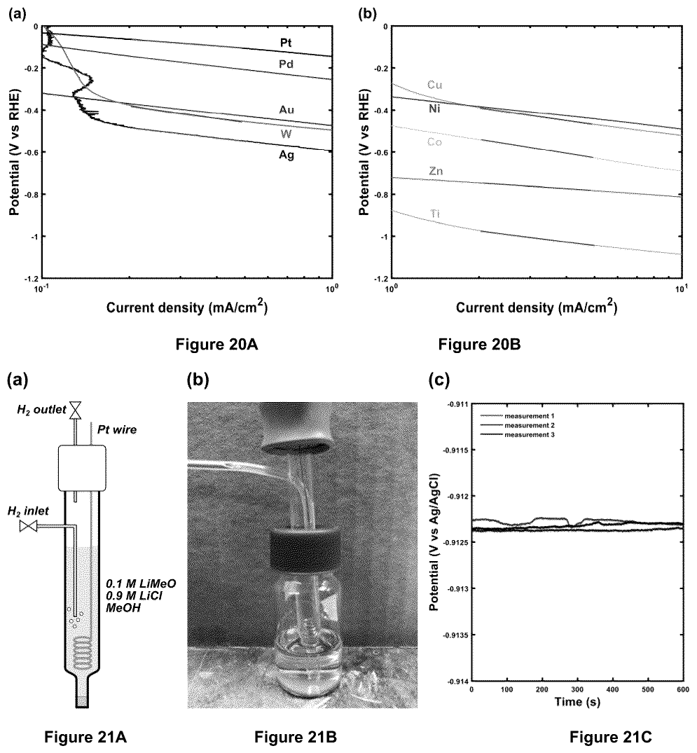

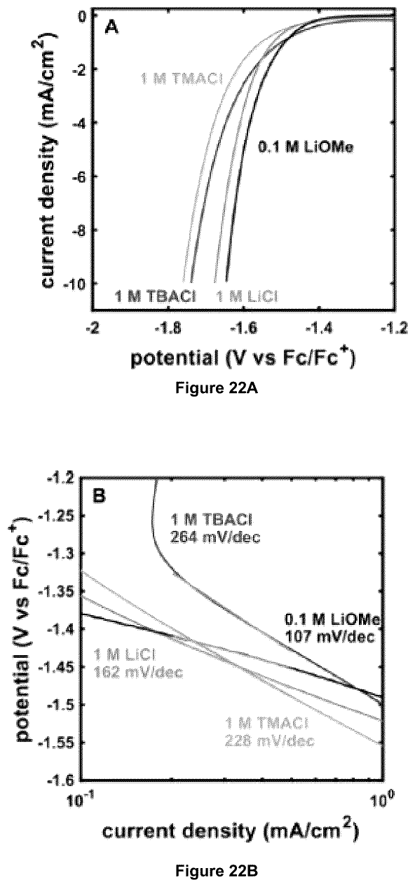

The HER equilibrium potential was measured using a custom reversible hydrogen electrode (FIG. 21). A platinum coil was immersed in a fritted glass reference electrode body containing 0.9 M LiCl and 0.1 M LiOMe in MeOH. Ultra-high-purity hydrogen gas (Airgas, 99.999%) was sparged through the electrolyte for 5 minutes. The inlet and outlet were sealed, and the RHE was immediately immersed in 1 M LiCl/MeOH. The open-circuit potential was measured against the Ag/AgCl (1 M LiCl/MeOH) reference electrode which was used in LSV experiments. The potential difference was measured for 10 minute and performed in triplicate (30 minutes total measurement time). The junction potential in the LSV experiment was determined by measuring the difference in the ferrocene formal redox potential between 1 M LiCl/MeOH and 0.1 M LiOMe/MeOH.

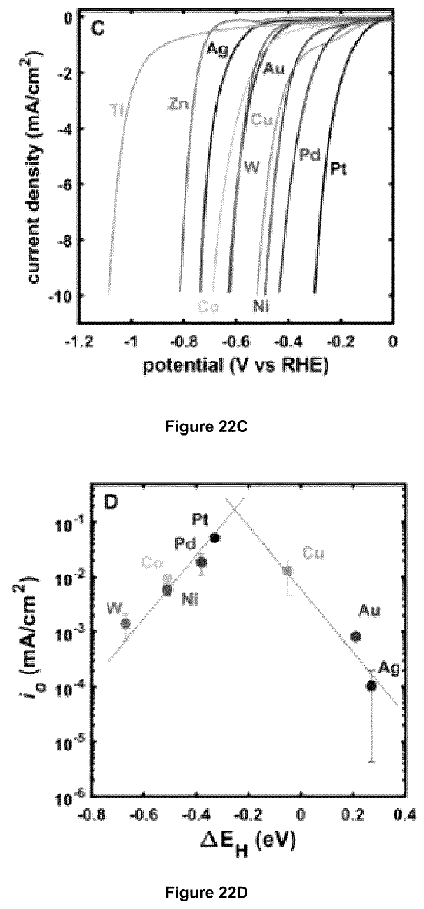

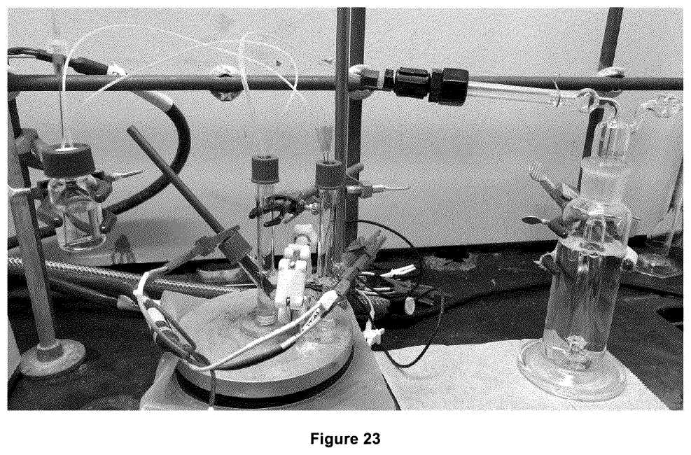

Next, the effect of electrode material on HER kinetics was evaluated. FIG. 22A shows LSV profiles for platinum, palladium, nickel, gold, silver, copper, titanium, cobalt, zinc, and tungsten in electrolytes containing 0.1 M LiOMe. Here, potentials are referenced against the reversible hydrogen electrode (RHE), which was measured externally by immersing a Pt coil in a hydrogen-saturated methanol electrolyte and measuring its potential relative to the Ag/AgCl reference electrode used during LSV measurements. Consistent with alkaline HER, Pt is the highest-performing catalyst, displaying the lowest onset potential, whereas other metals require ˜150-800 mV more negative potential to reach comparable current densities. The electrodes displayed a wide range of Tafel slopes from 100-200 mV dec⁻¹, suggesting HER likely displays different mechanistic features on these metals.

To quantitatively compare the metal electrodes, FIG. 22B shows the exchange current density plotted against the metal-hydrogen bond strength to give a volcano plot for HER catalysis. As expected, the intermediate bond strength for platinum yields the highest iₒ because strong metal-hydrogen bonding slows the desorption of hydrogen while weak metal-hydrogen bonding hinders the generation of adsorbed hydrogen. Surprisingly, Ni and Cu also perform relatively well compared to other metals, yielding only a ˜200 mV overpotential at the same current densities; while this certainly imposes a larger cell voltage, using more abundant catalysts could facilitate lower reactor costs.

### Example 5: Chlorine Evolution Experiments

Referring to FIG. 23, electrolysis experiments were performed in a small-volume H-cell (Adams & Chittenden). 5 mL of 1 M LiCl/MeOH was added to each side of the cell and equipped with PTFE stir bars. A GI-N417 PTFE fabric-reinforced chlor-alkali cation-exchange membrane separated the anode and cathode compartments. The membrane was cut into a 2.5 cm diameter circle and soaked in 1 M LiCl/MeOH for 24 h prior to electrolysis experiments. The anode compartment featured either a fine extruded graphite rod (GraphiteStore, 0.25″ diameter, ˜6.3 cm² in solution) or a Pt coil (BASi, 0.5 mm diameter, ˜3.1 cm² in solution. The cathode compartment always featured a Pt coil (BASi, 0.5 mm diameter). The Pt coil was used as received and washed between experiments using acetone. The graphite rod was polished with aluminum oxide polishing paper (Fiber Instrument Sales, Inc.) to a smooth finish and subsequently washed with acetone on a Kimwipe.

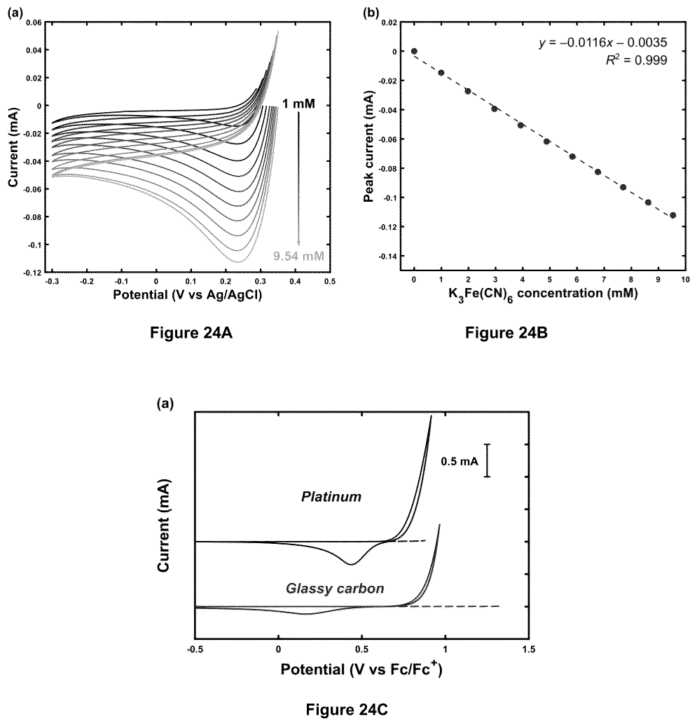

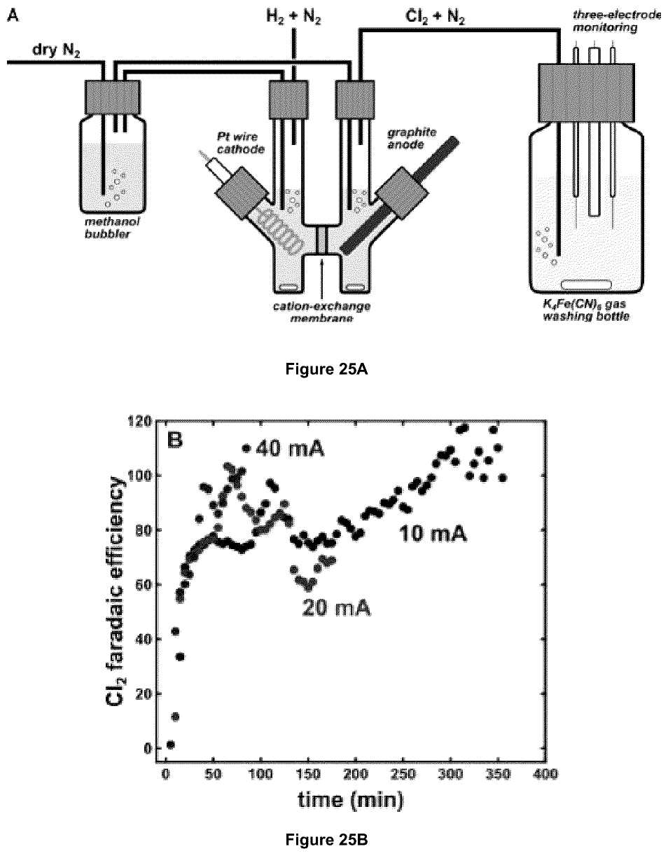

MeOH-saturated N₂ was continuously sparged through both sides of the cell; the total flow rate was kept constant at ˜0.1 SLPM and the flow appeared to be divided evenly between the anode and cathode. The cathode was vented to the atmosphere using two 20-gauge needles while the anode was passed through 1/16″ PFA tubing to a gas-washing tube containing 200 mL of freshly prepared 0.1 M K₄Fe(CN)₆ to immediate quench the generated chlorine. Chlorine generation was determined via voltametric measurement of Fe(CN)₆³⁻ concentration. Samples were extracted every 10 minutes from the gas washing solution using a polypropylene syringe connected via PFA tubing. 5 mL of sample was measured using a volumetric flask and the remaining solution was returned to the gas washing bottle. The sample was immediately transferred to a 20 mL scintillation vial and subject to cyclic voltammetry using a glassy carbon working electrode, platinum wire counter electrode, and Ag/AgCl (3 M KCl) reference electrode. CVs were recorded at 100 mV s⁻¹ from the open-circuit potential to −0.3 V vs Ag/AgCl and then allowed to rest for 5 minutes to allow the open-circuit potential to equilibrate. Voltammograms were measured in triplicate. The concentrations were determined using a calibration curve developed using varying concentrations of K₃Fe(CN)₆ added to 0.1 M K₄Fe(CN)₆ (FIG. 24). FIG. 24C compares cyclic voltammetry behavior in 1 M LiCl with that in 1 M LiClO₄ on both glassy carbon and platinum working electrodes. Voltammetry in 1 M LiCl displays a distinct oxidation current, corresponding to chlorine evolution, whereas 1 M LiClO₄ features a flat background current which increases with increasing concentration of chloride ions (FIG. 24).

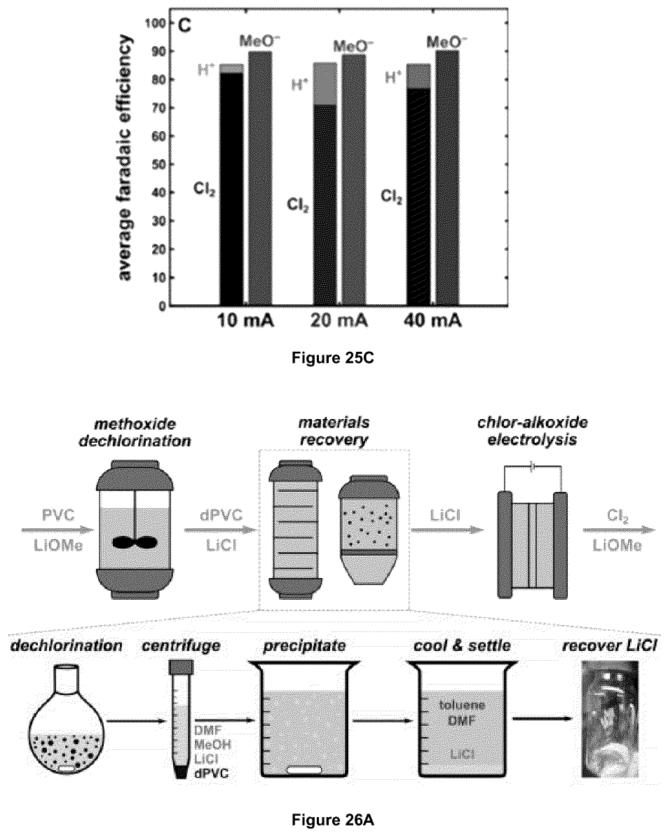

To verify chlorine generation and establish reaction conditions, preliminary electrolysis studies were conducted in an electrochemical H-cell (FIG. 25B) using a platinum coil cathode and a graphite rod anode. GI-N417, a PTFE reinforced perfluorosulfonic acid membrane, which is designed for use in chlor-alkali and saltwater electrolysis was used as the cation exchange membrane. The membrane was stable in methoxide-containing electrolytes and exhibits minimal swelling. Electrolysis was run under varying conditions and measured the yield of evolved chlorine from the anode and base from the cathode. Chlorine was immediately quenched using an aqueous potassium ferricyanide solution, which was subsequently used for determining yield via voltammetry.

FIG. 25C shows Cl₂ generation over time for electrolysis at 20 mA for graphite and platinum anodes. In all cases, chlorine yields are well below the theoretical yield assuming 100% faradaic efficiency, which were attributed to chlorine crossover arising via bubble formation near the membrane and solution-phase diffusion. Measuring the pH of the anode solution after the reaction gives acid concentrations of ca. 10 mM, accounting for only ˜10% of the missing charge. Further, the reduced chlorine yields correspond with limitations in methoxide generation—83% and 87% yields were obtained via acid titration for the graphite and platinum anodes, respectively. Chlorine would likely react with methoxide ions to generate formaldehyde and chloride ions, neutralizing the base. Without intending to be bound by theory, it is believed that these parasitic losses could be reduced through cell engineering by limiting gas collection near the membrane and enabling higher current operation by lowering the distance between the electrodes. Notably, a change in volume proceeds during electrolysis, as changes in ion concentration in both electrolytes result in osmotic flow of solvent from the anode to cathode compartment. Finally, no changes in color were observed within the anode chamber, indicating the generated chlorine is sparingly soluble in MeOH and exits the reactor in the gas phase. This low solubility is further evinced by the negligible increase in chlorine yield once the reaction has stopped.

Methoxide generation was determined by an acid-base titration using phenolphthalein in DI water. The cathode solution was taken from the reactor and diluted with DI water to 25 mL using a volumetric flask. 10 mL of 0.1 M HCl solution was measured by volumetric flask and added to a 125 mL Erlenmeyer flask containing 40 mL DI water, 1 mL of phenolphthalein indicator solution, and a PTFE stir bar. The diluted cathode solution was added dropwise from a 25 mL burette (+0.05 mL). The equivalence point was determined visually by the persistence of a pale pink color in the solution. Titrations were performed in duplicate.

### Example 6: Electrochemical Generation of Chlorine from Waste PVC

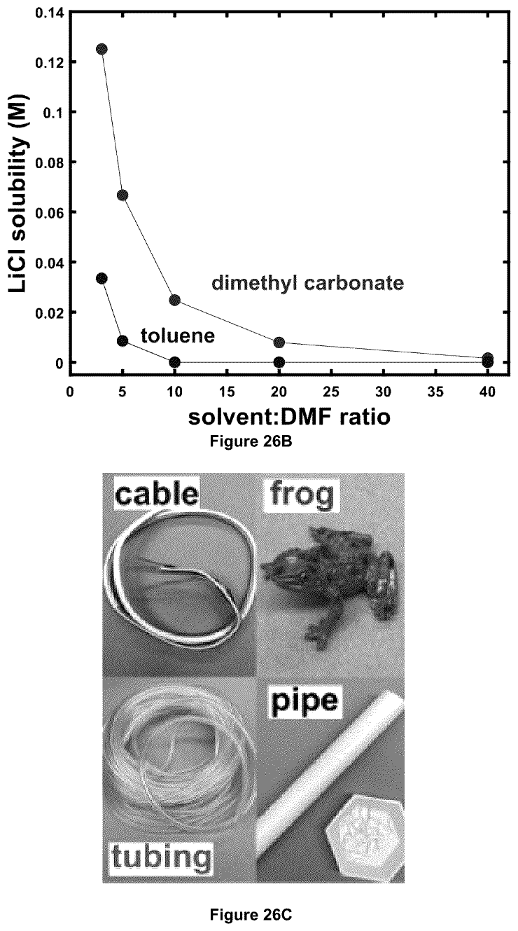

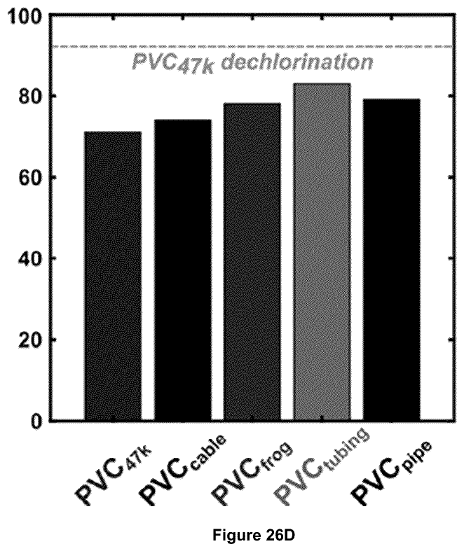

Demonstrative recycling was conducted on PVC₄₇ₖ as well as vinyl tubing (Tygon B-44-3), a toy plastic frog (purchased from Civaner through Amazon), wiring cable (Romex®) SIMpull®), and PVC pipe (Charlotte Pipe 7100), as shown in FIG. 26C.

The vinyl tubing (3.290 g) was cut into small pieces with scissors and dissolved in 40 mL of THF at 60° C. for about 30 min. The solution was poured into 200 ml of stirring MeOH at room temperature to precipitate the polymer, which was filtered and washed with 100 mL of MEOH. The white flaky polymer was dried under high vacuum overnight (about 18 h), yielding 2.174 g of PVC.

The toy frog was washed thoroughly with acetone on a Kimwipe to remove paint on the surface. The frog (1.986 g) was cut into small pieces with scissors, and dissolved in 20 L of THF at 60° C. for about 30 min. While still warm, the cloudy suspension was filtered through Chromafil GF/RC 1.0/0.20 μm syringe filters to remove insoluble fillers, yielding a clear solution. This solution was poured into 100 mL of stirring MeOH at room temperature to precipitate the polymer, which was filtered and washed with 50 mL of MeOH. The white, flaky polymer was dried under high vacuum overnight (about 18 h) yielding 0.798 g of PVC.

The cable insulation (1.990 g) was stripped from the wiring cable, cut into small pieces with scissors, and dissolved in 20 L of THF at 60° C. for about 30 min. While still warm, the cloudy suspension was filtered through Chromafil GF/RC 1.0/0.20 μm syringe filters to remove insoluble fillers, yielding a clear solution. This solution was poured into 100 ml of stirring MeOH at room temperature to precipitate the polymer, which was filtered and washed with 50 mL of MeOH. The white, flaky polymer was dried under high vacuum overnight (about 18 h) yielding 0.724 g of PVC.

A section of PVC pipe was initially frozen in liquid nitrogen and smashed into small pieces with a hammer. Then, the crushed PVC pipe (0.997 g) was dissolved in 20 L of THF at 60° C. for about 30 min. While still warm, the cloudy suspension was filtered through a Whatman® GF/D 2.7 μm glass fiber filter paper before being further filtered through Chromafil GF/RC 1.0/0.20 μm syringe filters to remove insoluble fillers, yielding a clear solution. This solution was poured into 100 mL of stirring MeOH at room temperature to precipitate the polymer, which was filtered and washed with 50 mL of MeOH. The white, flaky polymer was dried under high vacuum overnight (about 18 h) yielding 0.660 g of PVC.

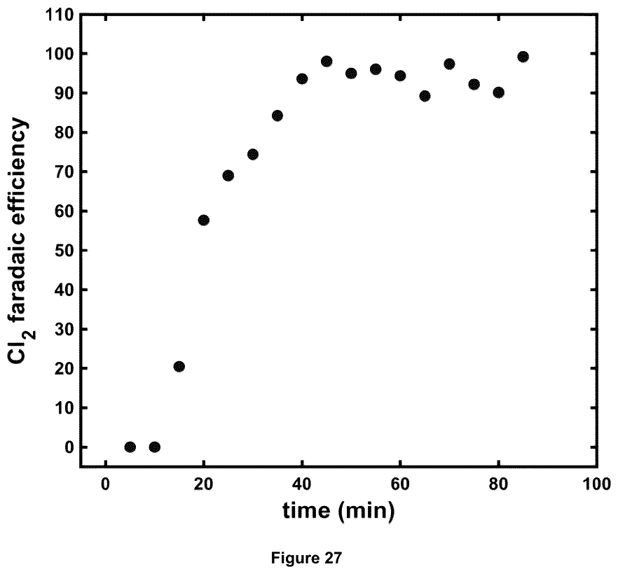

For each of the samples, after the dechlorinated polymer was removed via centrifugation, the supernatant was mixed in hot toluene (100° C.) to evaporate residual MeOH and precipitate LiCl. After cooling and sitting undisturbed overnight (16-20 hours), the precipitated LiCl was recovered either by filtration or by decanting the solvent. A 70% LiCl recovery was achieved using commercial PVC (FIG. 26D). Without intending to be bound by theory, it is believed that the remaining product remained sparingly soluble in the toluene mixture, as this small amount of material corresponded to LiCl concentrations below 0.5 mM. Using the recovered salt in chloro-alkoxide electrolysis gave comparable FE to pure LiCl salt (FIG. 27).

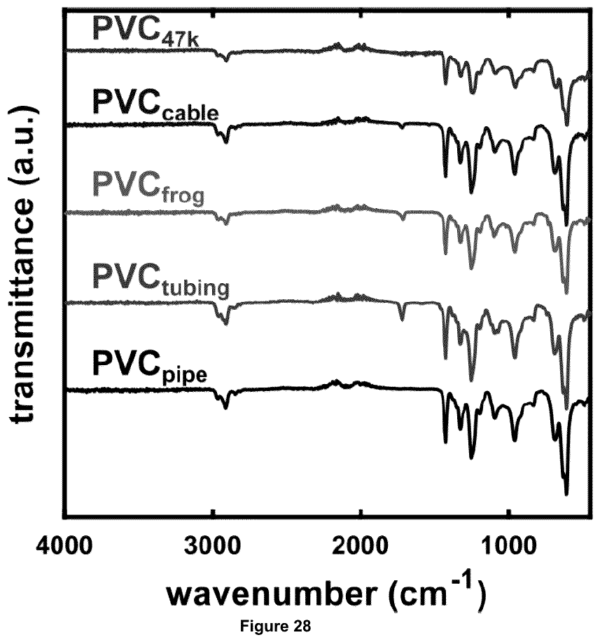

Referring to FIG. 28, all flexible PVC products—toy frog, tubing, and cable insulation-displayed small peak centered around 1700 cm⁻¹ that can be attributed to trace amounts of plasticizer remaining in the extracted resin.

The LiCl formed by PVC dechlorination must be extracted following the methoxide reaction and recycling into the chlor-alkoxide reactor. As such, this requires suitable separation methods to recover LiCl from the reaction mixture. To this end, precipitation in a non-solvent was leveraged to recover LiCl from DMF. A suitable solvent would display low LiCl solubility in the presence of DMF while exhibiting high tolerance toward chlorine evolution and methoxide generation in case the solvent is carried through the chemical/electrochemical reaction steps. Further, the solvent should be easily separable from DMF (e.g., by distillation). Several nonaqueous solvents miscible with DMF were considered-halogenated solvents, ethers, carbonates, and toluene. Although dichloromethane and chloroform should exhibit low LiCl solubility, these solvents are unstable in the presence of alkoxides. Ethers (e.g., tetrahydrofuran, diethyl ether) are readily oxidized by chlorine. Dimethyl carbonate exhibits relatively low LiCl solubility (FIG. 26B), however other carbonate solvents would likely undergo methanolysis to form dimethyl carbonate. Of the available solvents, mixtures with toluene displayed the lowest solubility, thus giving the highest potential LiCl recovery with the fewest volume equivalents (FIG. 26B). Toluene should also be readily separated from DMF via distillation to facilitate solvent recycling.

The recycling process enabled similar LiCl recovery for both PVC materials (FIG. 26D) and the dPVC products displayed comparable FTIR spectra to dechlorination with pure PVC. Note that the toy frog exhibited a LiCl yield well above 100%, which was attributed to inaccuracies in measuring PVC content. Removing additives prior to dechlorination enabled access to pure PVC—labeled PVC_{frog}, PVC_{cable}, PVCₚᵢₚₑ, and PVC_{tubing}—ensuring a more accurate PVC mass input. Again, a high yield of LiCl was recovered from the dechlorination reaction (FIG. 26D), confirming the efficacy of method of the disclosure. The introduction of pretreatment steps may add unit operations to the process, but may also lower the methanol requirements for plasticizer methanolysis and the complexity of downstream plasticizer separation.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A method for generation of hydrogen and/or halogen from a waste source comprising at least one halogen containing polymer, comprising:
admixing the waste source with a solvent to dissolve the at least one halogen containing polymer in the waste source;
admixing the solvent having the at least one halogen containing polymer dissolved therein with an alkoxide base under conditions to dehalogenate the at least one halogen containing polymer and precipitate at least one dehalogenated polymer, resulting in an admixture comprising the precipitated at least one dehalogenated polymer, a halogen salt, and an alkyl alcohol;
separating the precipitated at least one dehalogenated polymer from the admixture, wherein the halogen salt and the alkyl alcohol remain in the solvent;
introducing the halogen salt and the alkyl alcohol into an electrochemical cell comprising a cathode and an oppositely disposed anode, wherein upon application of a voltage, halogen ions from the halogen salt are converted to a halogen gas at the anode and the alkyl alcohol reacts at the cathode to generate an alkoxide and hydrogen gas; and
recovering the halogen gas and the hydrogen gas from the electrochemical cell.

2. The method of claim 1, wherein admixing the solvent comprising the at least one halogen containing polymer with the alkoxide base comprises adding the solvent comprising the at least one halogen containing polymer dropwise to the alkoxide base.

3. The method of claim 1, wherein admixing the solvent comprising the at least one halogen containing polymer and the alkoxide base comprises heating to a temperature of about 20° C. to about 100° C.

4. The method of claim 1, wherein the admixture comprises 1 to 2 eq of the alkoxide base.

5. The method of claim 1, wherein the waste source comprises polyvinyl chloride.

6. The method of claim 1, wherein the waste source is a mixed plastic waste source comprising halogenated and non-halogenated polymers.

7. The method of claim 6, wherein the non-halogenated polymer comprises polyolefins and/or one or more polymers with ester functionality.

8. The method of claim 1, wherein the waste source comprises one or more plasticizers.

9. The method of claim 8, wherein the one or more plasticizers comprise phthalate plasticizers, optionally wherein the phthalate plasticizer is di-2-ethylhexyl phthalate (DEHP).

10. The method of claim 1, wherein the at least one halogen containing polymer comprises one or more of F, Cl, Br, and I.

11. The method of claim 1, wherein the solvent is one or more of dimethylformamide, tetrahydrofuran, dimethoxyethane, propylene, carbonate, acetonitrile, methanol, ethanol, and tert-butanol.

12. The method of claim 1, wherein the alkoxide base is a methoxide base, an ethoxide base, a tert-butoxide base, or an isopropoxide base.

13. The method of claim 1, wherein the at least one halogen containing polymer is a chloride containing polymer and the alkoxide is a methoxide base.

14. The method of claim 13, wherein the methoxide base is tetrabutylammonium methoxide (TBA-OMe) or lithium methoxide (LiOMe).

15. The method of claim 1, wherein the methoxide base is a tetraalkylammonium methoxide, the halogen salt is tetraalkylammonium salt, and the alkyl alcohol is methanol.

16. The method of claim 1, wherein the methoxide base is lithium methoxide, the halogen salt is lithium chloride, and the alkyl alcohol is methanol.

17. The method of claim 1, further comprising separating the the halogen salt from the solvent after separating out the at least one dehalogenated polymer and before introducing the halogen salt into the electrochemical cell.

18. The method of claim 17, wherein the halogen salt is separated by liquid-liquid extraction or precipitation.

19. The method of claim 1, wherein the electrochemical cell comprises an electrolyte selected from methanol containing lithium chloride, tetramethylammonium chloride, or tetrabutylammonium chloride.

20. The method of claim 1, wherein the current density is 1 mA/cm² to 1 A/cm².
